(19) United States
(12) Patent Application Publication
(10) Pub. No.: US 2017/0142610 A1
(43) Pub. Date: May 18, 2017

(54) COMMUNICATION DEVICE

(71) Applicant: NEC Corporation, Minato-ku, Tokyo (JP)

(72) Inventor: Koichi NIHEI, Tokyo (JP)

(73) Assignee: NEC Corporation, Minato-ku, Tokyo (JP)

(21) Appl. No.: 15/129,589

(22) PCT Filed: May 19, 2015
(86) PCT No.: PCT/JP2015/002516

§ 371 Date: Sep. 27, 2016

(30) Foreign Application Priority Data
May 22, 2014 (JP) 2014-105797

(51) Int. Cl. H04W 28/02; H04W 24/08

(52) U.S. Cl. CPC H04W 28/0236; H04W 24/08

(57) ABSTRACT

In order to solve a problem of difficulty in performing a communication at a higher bit rate while suppressing a delay generated by a transmission error, a communication device which communicates with another communication device via a relay device includes a detection unit that detects a state of a communication path to the relay device, and a control unit that controls a transmission time of data to be transmitted to the other communication device depending on the state of a communication path.

### TECHNICAL FIELD

The present invention relates to a communication device, a communication control method, a communication system, and a communication device which communicates with another communication device by an action of a program.

### BACKGROUND ART

In order to realize a highly reliable data communication, a communication device or a communication system which performs retransmission when a transmission error occurs is proposed or commercialized.

For example, as a first related art of the present invention, proposed is a wireless communication device in which a TCP (Transmission Control Protocol) operates a timer when a packet is transmitted, and determines, when a packet containing an ACK (Acknowledgement) signal is not received by a timeout value, that the transmitted packet is lost, and performs a retransmission operation (for example, see Patent Literature 1). In the first related art, when the received packet containing an ACK signal for a packet transmitted from a communication device to another communication device is received early, the packet is output to the TCP to reach a predetermined RTT (Round Trip Time). Since this suppresses the operation of a retransmission function in TCP, occurrence of a retransmission packet is also suppressed.

As a second related art of the present invention, it is proposed that, when a data loss is occurred on each of a plurality of communication paths connecting communication devices, retransmission of data is performed by a communication protocol on each path (for example, see Patent Literature 2). In the second related art, a communication device calculates the data loss occurrence probability from a data loss occurrence state when data is transmitted/received, and at the same time, acquires the data loss occurrence probability which was calculated by the communication counterpart. The communication device controls the data size per one data transmission to be reduced in accordance with the increase in the data loss occurrence probability when the data loss occurrence probability is higher than a predetermined value.

As a third related art of the present invention, there is a technique in which, in a VoIP (Voice over Internet Protocol) communication via a wireless interface, a bit rate of a VoIP voice is controlled in accordance with a modulation system and a coding rate (MCS, Modulation and Coding Scheme) which are determined based on a wireless state (for example, see Patent Literature 3).

### CITATION LIST

### Patent Literature

[PTL 1] Japanese Unexamined Patent Application Publication No. H11-220512
[PTL 2] WO 2011/037245
[PTL 3] Japanese Unexamined Patent Application Publication (Translation of PCT Application) No. 2008-543168

### SUMMARY OF INVENTION

### Technical Problem

In an LTE (Long Term Evolution) which is a communication standard for cellular phones, MCS is controlled depending on a wireless state between a base station and a terminal. When the wireless state is favorable, a high communication throughput is realized by reducing redundant data by using a modulation system having a high coding efficiency. On the other hand, when the wireless state is not favorable, a communication can be continued by increasing redundant data by using a modulation system having a low coding efficiency which is less likely to generate a transmission error although a throughput decreases. In an LTE, in order to maximize a communication throughput, an MCS is controlled in such a way that a transmission error occurs at a certain rate. When a transmission error occurs, error recovery is performed by performing a retransmission which is called ARQ (Automatic Repeat reQuest) or HARQ (Hybrid ARQ). However, when a transmission error occurs and a retransmission is performed, a communication delay is increased, and therefore, a user's sensible quality decreases in a real time communication such as VoIP. In particular, when a transmission error continuously occurs, a delay of the data suddenly increases, and therefore, a sound interruption occurs, and a user's sensible quality is considerably deteriorated. It is thus important to generate a transmission error as infrequently as possible. A transmission error occurrence rate varies greatly depending on settings of a base station or a terminal, the magnitude of a variation of a wireless state, or the like even though the MCS is the same. For this reason, in a method in which a bit rate is controlled in accordance with a MCS as described in the third related art, a delay which is generated by a transmission error cannot be controlled.

The above-described problems occur not only in an LTE, but also in many wireless communication systems such as 3G (3rd Generation), WiMAX (Worldwide Interoperability for Microwave Access), and Wi-Fi (Wireless Fidelity). Even when the above-described second related art is used and the data size per one data transmission is reduced in accordance with the increase in the data loss occurrence probability, if the next data transmission is started immediately, the probability of encountering a transmission error is not changed compared with the case in which the data size per one data transmission is large.

### Object of Invention

An object of the present invention is to provide a communication device which solves the above-described problem, i.e., a problem of difficulty in performing a communication at a higher bit rate while suppressing a delay generated by a transmission error.

### Solution to Problem

A communication device which communicates with another communication device via a relay device according to a first aspect of the invention includes a detector that detects a state of a communication path to the relay device and a controller that controls a transmission time of data to be transmitted to the other communication device depending on the state of a communication path.

A communication control method executed by a communication device which communicates with another communication device via a relay device according to a second aspect of the invention, includes detecting a state of a communication path to the relay device and controlling a transmission time of data to be transmitted to the other communication device depending on a state of the communication path.

A program according to a third aspect of the invention makes a computer which communicates with a communication device via a relay device function as a detector that detects a state of a communication path to the relay device and a controller that controls a transmission time of data to be transmitted to the other communication device depending on the state of the communication path.

A communication system according to a fourth aspect of the invention in which a first communication device and a second communication device perform a communication via a relay device, wherein the first communication device includes a detector that detects a state of a communication path to the relay device and a controller that controls a transmission time of data to be transmitted to the second communication device depending on a state of the communication path.

### Advantageous Effects of Invention

Since the present invention includes the above-described configuration, it becomes possible to perform a communication at a higher bit rate while suppressing a transmission error.

### BRIEF DESCRIPTION OF DRAWINGS

FIG. 1 is a configuration diagram of a communication system according to a first exemplary embodiment of the present invention.

FIG. 2 is a configuration diagram of a first communication device according to the first exemplary embodiment of the present invention.

FIG. 3 is a flow chart representing an operation of the first communication device according to the first exemplary embodiment of the present invention.

FIG. 4 is a configuration diagram of a first communication device of a second exemplary embodiment of the present invention.

FIG. 5 is a flow chart representing an operation of the first communication device according to the second exemplary embodiment of the present invention.

FIG. 6 is a configuration diagram of a communication system according to a third and a fourth exemplary embodiment of the present invention.

FIG. 7 is one example of a table stored in a parameter storage unit according to the first communication device of the present invention.

FIG. 8 is another example of a table stored in a parameter storage unit according to the first communication device of the present invention.

FIG. 9 is still another example of a table stored in a parameter storage unit according to the first communication device of the present invention.

FIG. 10 is a first flow chart representing an operation of a data determination unit of the first communication device according to the third exemplary embodiment of the present invention.

FIG. 11 is a second flow chart representing an operation of the data determination unit of the first communication device according to the third exemplary embodiment of the present invention.

FIG. 12 is a configuration diagram of a communication device according to a fifth exemplary embodiment of the present invention.

FIG. 13 is a flow chart illustrating a detailed operation of step S305 in a sixth exemplary embodiment of the present invention.

FIG. 14 is one example of the occurrence frequency of a sound interruption for a predicted transmission interval and a codec class in the sixth exemplary embodiment of the present invention.

FIG. 15 is an example of calculated R value in the sixth exemplary embodiment of the present invention.

FIG. 16 is a configuration diagram illustrating a modified example according to the third exemplary embodiment and the fourth exemplary embodiment of the present invention.

### DESCRIPTION OF EMBODIMENTS

Next, exemplary embodiments of the present invention will be described in detail with reference to the Drawings.

### First Exemplary Embodiment

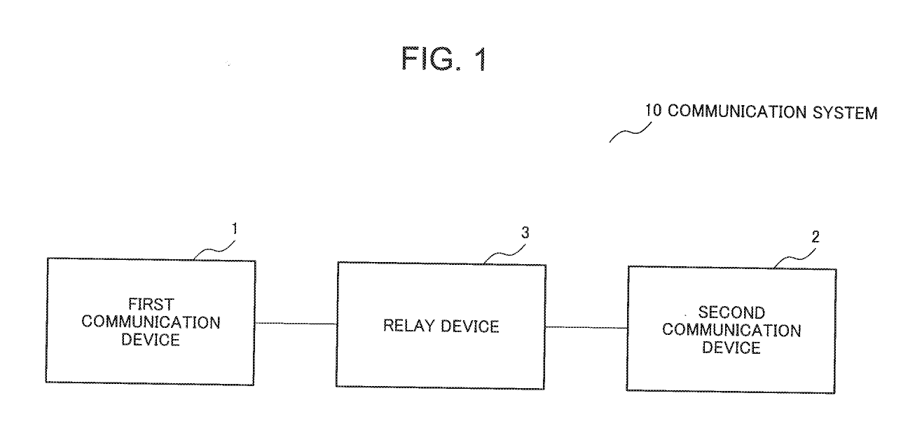

FIG. 1 is a configuration diagram of a communication system 10 according to a first exemplary embodiment of the present invention. The communication system 10 includes a first communication device 1, a second communication device 2, and a relay device 3. The first communication device 1 and the second communication device 2 are connected with each other via a relay device 3. Although, in FIG. 1, only one relay device 3 is illustrated, there may be a plurality of relay devices 3 between the first communication device 1 and the second communication device 2. The first communication device 1 and the relay device 3 are connected with each other via a network in which one or both of a modulation system and a coding rate is/are controlled depending on the signal intensity or the like.

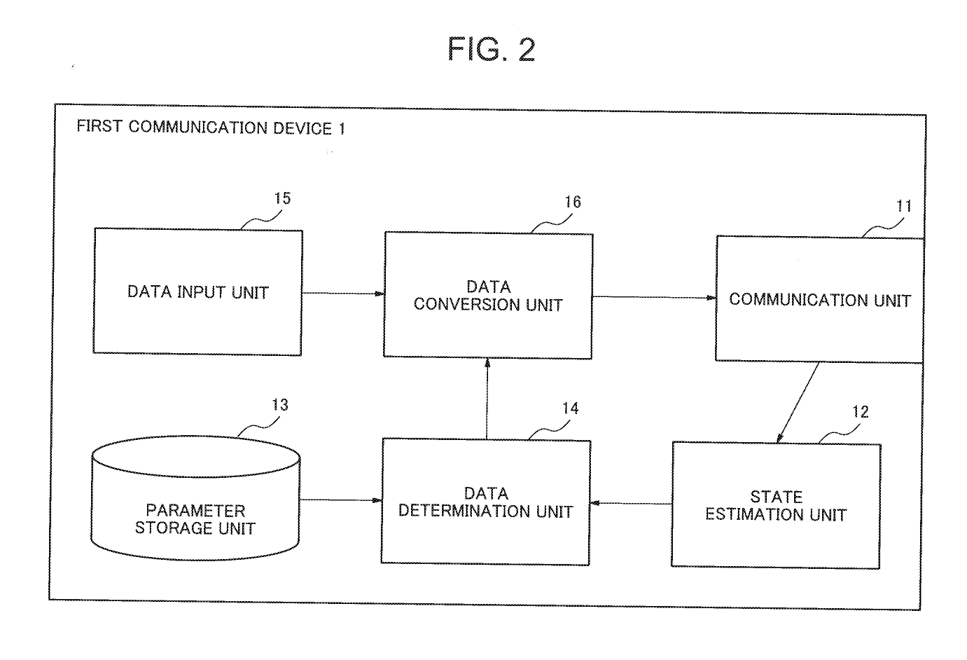

FIG. 2 is a configuration diagram of the first communication device 1. The first communication device 1 includes a communication unit 11, a state estimation unit 12, a parameter storage unit 13, a data determination unit 14, a data input unit 15, and a data conversion unit 16. The communication unit 11 performs communication with the relay device 3. The state estimation unit 12 acquires information from the communication unit 11, and estimates a communication state with the relay device 3. The parameter storage unit 13 stores a predetermined set value (parameter). The data determination unit 14 determines the size and time of transmitted/received data based on an output from the state estimation unit 12 and the parameter stored in the parameter storage unit 13. To the data input unit 15, data to be transmitted is input. The data conversion unit 16 converts the size of the data input from the data input unit 15 based on an instruction from the data determination unit 14, and transmits the converted data to the communication unit 11 at an instructed time.

### Description of Operation

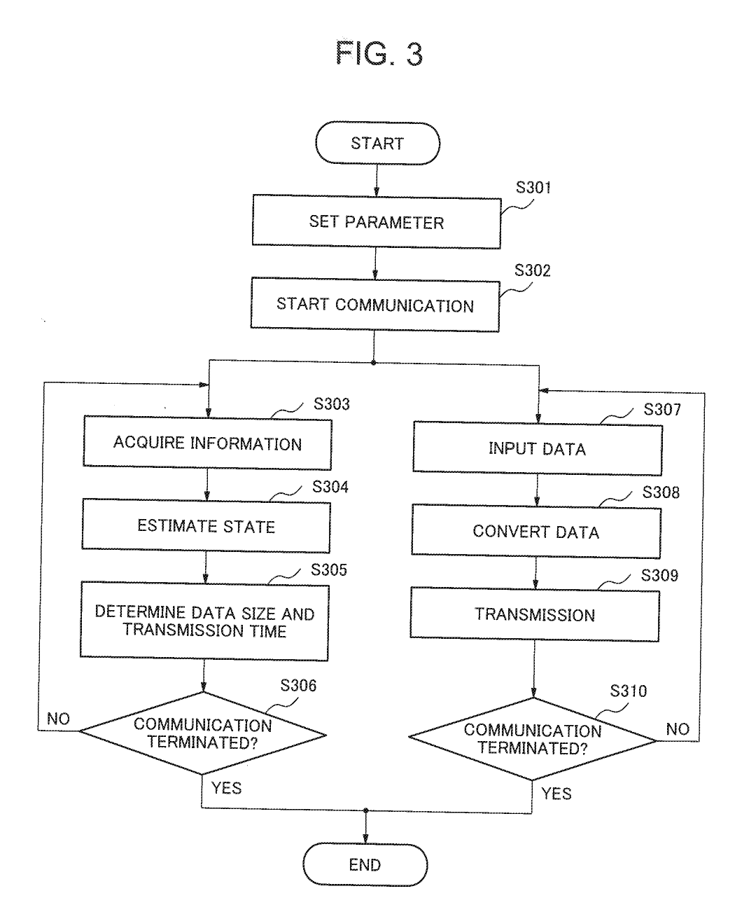

FIG. 3 is a flow chart illustrating an operation of the first communication device 1 in the first exemplary embodiment of the present invention. The first communication device 1 stores a parameter needed for determining the data size and time in the parameter storage unit 13 when an operation is started (step S301), and starts a communication (step S302).

The state estimation unit 12 acquires information which can be acquired from a network between the first communication device 1 and the relay device 3 from the communication unit 11 (step S303), and estimates a state of the network from the acquired information (step S304). When information which can be acquired from a network itself represents the state of the network, the step S304 may be omitted. Next, the data determination unit 14 determines the data size and a transmission time for suppressing a delay of data to be transmitted based on information about the acquired and estimated network in the state estimation unit 12, and instructs the determined contents to the data conversion unit 16 (step S305). The first communication device 1 executes the above-described processing at a constant interval or using a state variation or the like as a trigger.

The first communication device 1, when data to be transmitted is input from the data input unit 15 (step S307), transmits the data to the data conversion unit 16. The data conversion unit 16 then converts the data received from the data input unit 15 in such a way that the size of the data becomes the size instructed from the data determination unit 14 (step S308). The data conversion unit 16 transmits the converted data to the communication unit 11 at the time instructed from the data determination unit 14, and transmits the data from the communication unit 11 (step S309). The first communication device 1 executes the above-described processing until a communication terminates (S306 and S310).

Next, an effect of the present exemplary embodiment will be described. In the present exemplary embodiment, the data determination unit 14 determines the data size and a transmission time of data to be transmitted based on the information acquired from the state estimation unit 12 and the parameter stored in the parameter storage unit 13. As a result, a communication can be performed at a higher bit rate while suppressing occurrence of a transmission error. In the present exemplary embodiment, a communication is possible with a small delay by suppressing a delay due to retransmission.

### Second Exemplary Embodiment

Next, a second exemplary embodiment of the present invention will be described in detail with reference to the Drawings.

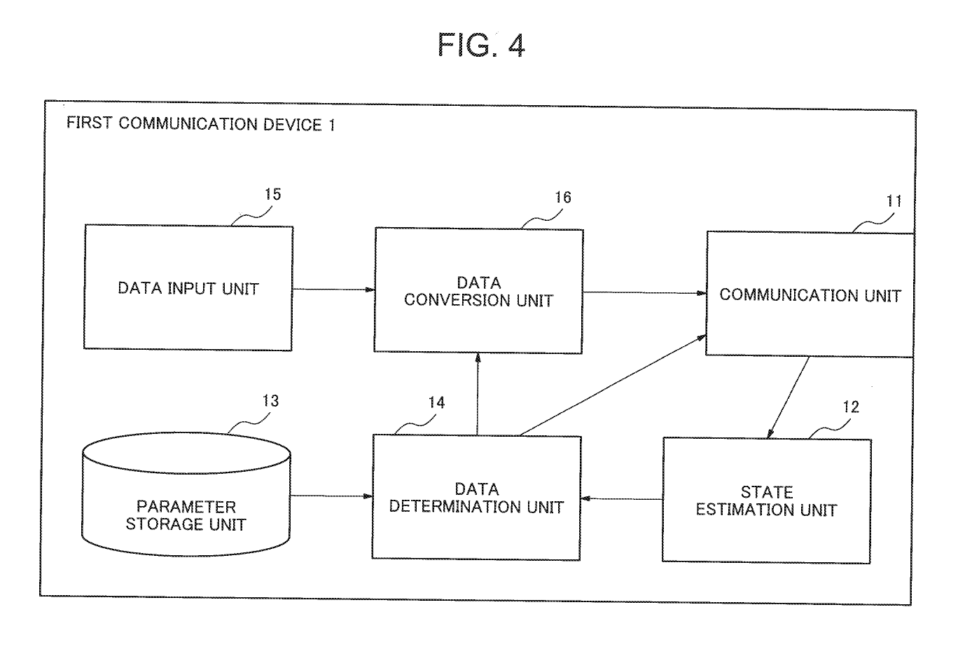

FIG. 4 is a configuration diagram of a first communication device 1 of the second exemplary embodiment. The first communication device 1 of the present exemplary embodiment is different from the first exemplary embodiment in that the data determination unit 14 and the communication unit 11 are connected with each other, and the data determination unit 14 instructs the data size and a transmission time to the second communication device 2 via the communication unit 11. In other words, in the present exemplary embodiment, the first communication device 1 controls the size and a transmission time of not only data transmitted by the first communication device 1 but also data received by the first communication device 1 from the second communication device 2.

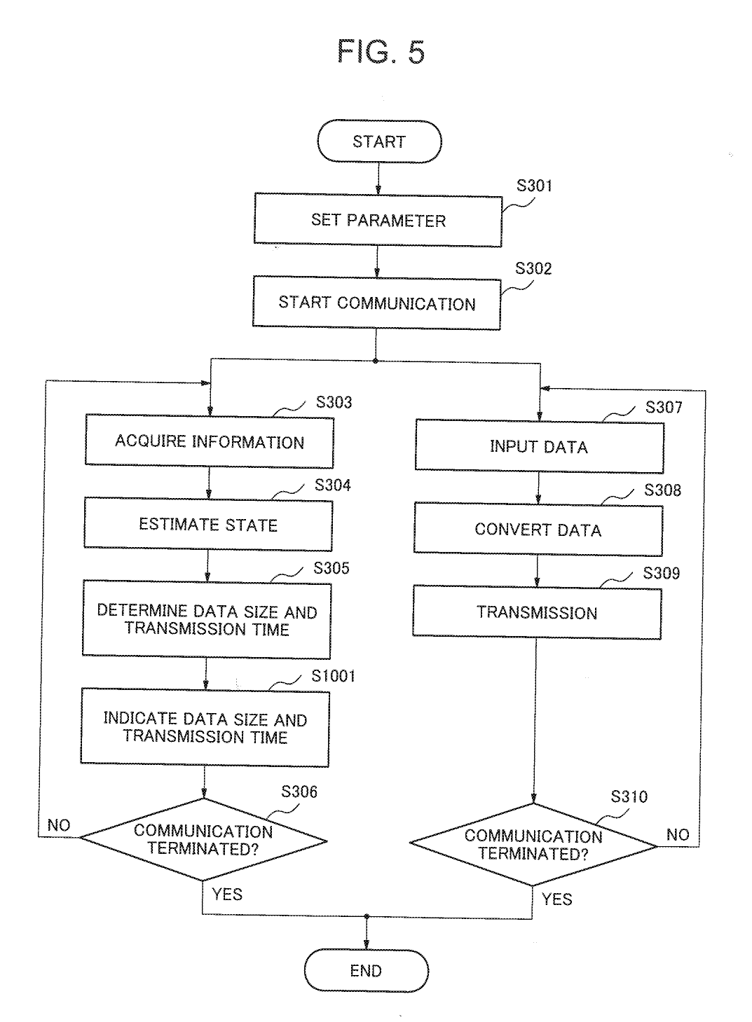

FIG. 5 is a flow chart illustrating an operation of the first communication device 1 of the present exemplary embodiment. The present exemplary embodiment is different from the first exemplary embodiment in that the present exemplary embodiment comprises step S1001 after acquiring information (step S303), estimating a state (step S304), determining the data size and a transmission time (step S305). In the step S1001, not only is a processing performed for the upward direction in which data is transmitted from the first communication device 1, a processing similar to the upward direction is also performed for the downward direction in which data transmitted by the second communication device 2 is received, and the data size and a transmission time are indicated to the second communication device 2. The second communication device 2 includes portions corresponding to the data input unit 15, the data conversion unit 16, and the communication unit 11 of FIG. 2, and the data conversion unit 16 of the second communication device 2 controls the size and the transmission time of data input from the data input unit 15 of the second communication device 2 in accordance with the data size and the transmission time instructed from the first communication device 1.

Next, effects of the present exemplary embodiment will be described. In the present exemplary embodiment, by indicating the data size and the transmission time from the first communication device 1 to the second communication device 2, a delay of data received by the first communication device 1 can be suppressed.

### Third Exemplary Embodiment

A third exemplary embodiment more embodies the first exemplary embodiment.

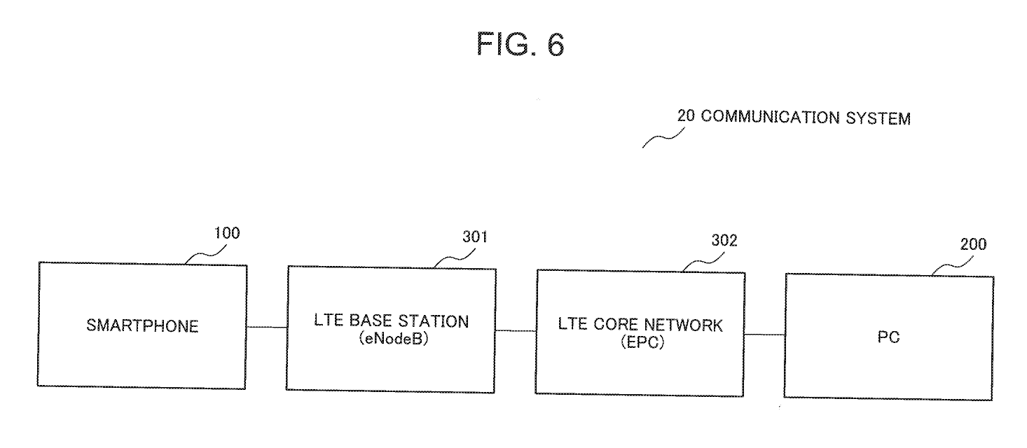

FIG. 6 is a configuration diagram of the communication system 20 of the third exemplary embodiment.

The first communication device 1 included in the communication system 20 is a smartphone 100, and the second communication device 2 is a personal computer (PC) 200. The relay device 3 in the first exemplary embodiment is composed of an eNodeB (Evolved Node B) 301 which is a base station device of LTE and an EPC (Evolved Packet Core) 302 which is a core network.

The smartphone 100 and an LTE base station 301 communicate with each other based on an LTE system defined by 3GPP (3rd Generation Partnership Project). The LTE core network 302 and the PC 200 are connected with each other by the Internet and a LAN (Local Area Network).

The communication unit 11 of the smartphone 100 is composed of a device for LTE communication, a device driver, and the like. In the smartphone 100, the state estimation unit 12, the data determination unit 14, and the data conversion unit 16 are configured by a CPU and a program executed thereon. The parameter storage unit 13 is a storage area secured on a main memory of the smartphone 100. The data input unit 15 is an input device included in a smartphone such as a microphone, a camera, a button, or a touch panel. The data input unit 15 may be a sensor device such as a GPS (Global Positioning System) receiver, an acceleration sensor, or a temperature sensor.

The PC 200 is a common personal computer, and comprises an input device such as a keyboard, a mouse, a microphone, a camera. The PC 200 can execute an arbitrary application program, and can be connected to a network via an interface.

First, a voice call between the smartphone 100 and the PC 200 will be studied. In this case, the data input unit 15 of the smartphone 100 is a microphone. A voice input from the data input unit 15 is encoded in the data conversion unit 16 by a voice codec such as G.711 or AMR (Adaptive Multi-Rate). To the encoded voice data, a header of RTP (Real-time Transport Protocol), UDP (User Datagram Protocol), or the like is added, and the encoded voice data is transmitted from the communication unit 11. A voice packet transmitted from the communication unit 11 reaches the PC 200 via the LTE base station 301 and the LTE core network 302. The reached voice packet is decoded by an application program executed on the PC 200, and output from a speaker. Similarly, a voice input from microphone of the PC 200 is encoded and transmitted to the smartphone 100, and received by the communication unit 11 of the smartphone, and then decoded and reproduced (not illustrated).

When communication of a voice packet is started, the state estimation unit 12 acquires information of a wireless network from the communication unit 11. Information to be acquired is a type of MCS which is currently used, an SINR (Signal-to-Interference and Noise power Ratio), a retransmission occurrence frequency, or the like. The SINR is a parameter representing whether the radio wave state is good or not. An information acquisition procedure of the information estimation unit 12 may be a polling system in which information is periodically acquired, or may be a call back system in which the communication unit 11 notifies a change of information.

The data determination unit 14 determines the optimal data size and a transmission time by the following procedure based on information acquired in the state estimation unit 12 and a parameter stored in the parameter storage unit 13.

Main causes for increases of delays in LTE are a transmission error of control information and a transmission error of user data (in the case of the present exemplary embodiment, a voice packet).

A transmission error of control information occurs by an error of a message for notifying resource assignment information from a base station to a terminal. In LTE, a base station manages a wireless resource. A base station determines which resource is assigned to which terminal for each millisecond, and notifies the determined assignment as control information to a terminal. The control information is collectively transmitted to all subordinate terminals. For this reason, a base station uses a modulation system having a low coding efficiency in such a way that even a terminal which is far from the base station and in a poor wireless environment can receive control information. As the result, a large amount of redundant data is added to control information and transmitted. However, there are still cases in which a terminal in a poor wireless environment cannot receive control information. When control information is lost, a terminal cannot know whether transmission/reception is possible, and therefore, the terminal cannot transmit/receive data for a long time from a timeout until retransmission of control information. Assuming the probability of the control information loss to be constant, the longer the transmission interval of a voice is, the lower the probability of delay occurrence due to overlapping between control information loss and transmission time is. Accordingly, when the smartphone 100 has a poor radio wave state, a transmission interval of a voice packet is extended. In a control procedure of a transmission interval, an optimal packet transmission interval for the value of an MCS or an SINR may be stored in the parameter storage unit 13 as a parameter based on a verification which has been performed in advance, and the transmission interval may be controlled based on a current MCS or SINR. In this case, the newest measurement value for the MCS or the SINR may be used, or a smoothed data using past measurement values may be used.

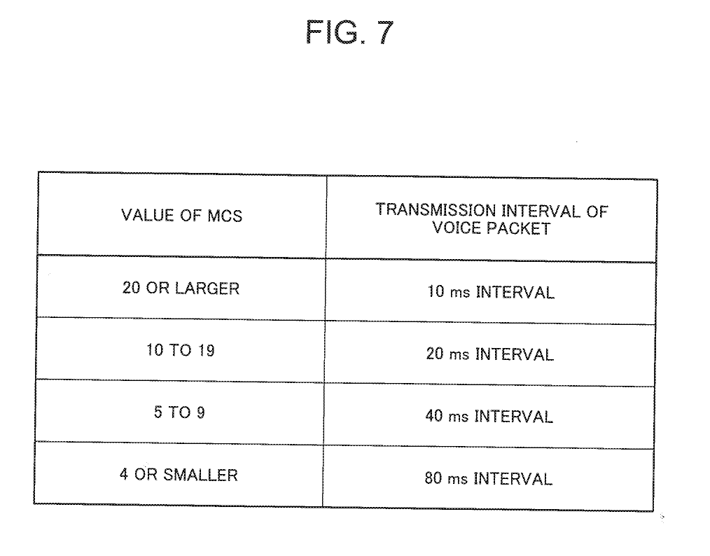

FIG. 7 is an example of information stored in the parameter storage unit 13. In the example of FIG. 7, a transmission interval of a voice packet corresponding to the value of the MCS is stored.

For example, an entry in the first line stores that a transmission interval of a voice packet should be 10 ms when the value of the MCS is 20 or higher. An entry in the fourth line stores that a transmission interval of a voice packet should be 80 ms when the value of the MCS is 4 or lower.

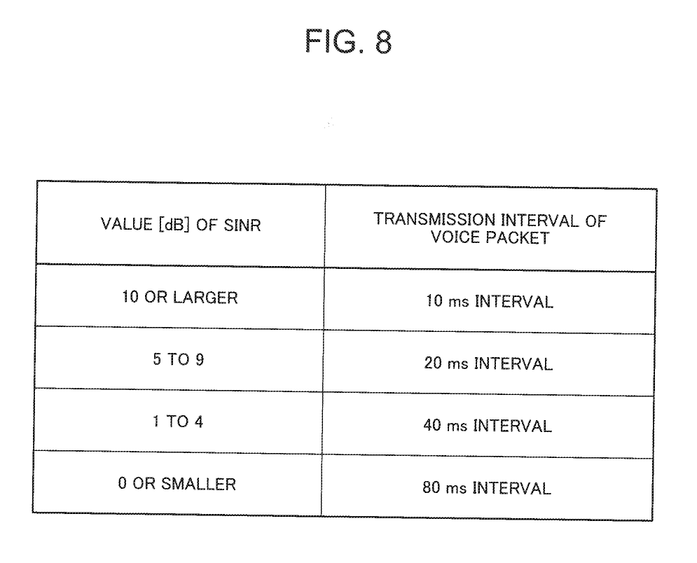

FIG. 8 is another example of information stored in the parameter storage unit 13. In the example of FIG. 8, a transmission interval of a voice packet corresponding to the value of SINR is stored. For example, an entry in the first line stores that a transmission interval of a voice packet should be 10 ms when the value of the SINR is 10 dB or higher. An entry in the fourth line stores that a transmission interval of a voice packet should be 80 ms when the value of the SINR is 0 dB or lower.

Although a transmission error of user data constantly occurs, the error can be recovered usually by about one retransmission (HARQ), and therefore, an increase in delay time is about several milliseconds. However, when a large amount of data is transmitted in an environment having a low MCS (i.e., low coding efficiency), the number of wireless resources to be used (which is called “resource blocks”) increases. As a result, a transmission error is likely to occur, and a transmission error continuously occurs, thereby increasing a delay. It is therefore important to control the size of a voice packet (voice quality) depending on an MCS or SINR, thereby decreasing the occurrence probability of consecutive transmission errors. Accordingly, the amount of data which can be transmitted by one resource block may be calculated from the value of the MCS to control the size of a voice packet to be transmitted per unit time in such a way that the number of resource blocks to be used per unit time is a certain number or smaller. The number of resource blocks per unit time needs not be constant. For example, the occurrence probability of a transmission error may be estimated from the MCS or the SINR to control the number of resource blocks per unit time in such a way that the probability that a certain number or more of transmission errors continue is a certain value or smaller. In this case, the number of resource blocks per unit time may be determined taking into consideration the number of past transmission errors and retransmissions.

Regarding both control information and user data, when a radio wave environment (i.e., communication environment) abruptly deteriorates, the control of the MCS may not be in time and the transmission error occurrence rate may increase, which may increase the delay. For this reason, by increasing a transmission interval in an environment in which variation of a radio wave environment is drastic, the probability that the timing of abrupt deterioration of a radio wave environment coincides the timing of packet transmission can be decreased. As an indicator representing the intensity of a variation of a communication environment, for example, a variance of SINR in a past certain period of time can be used.

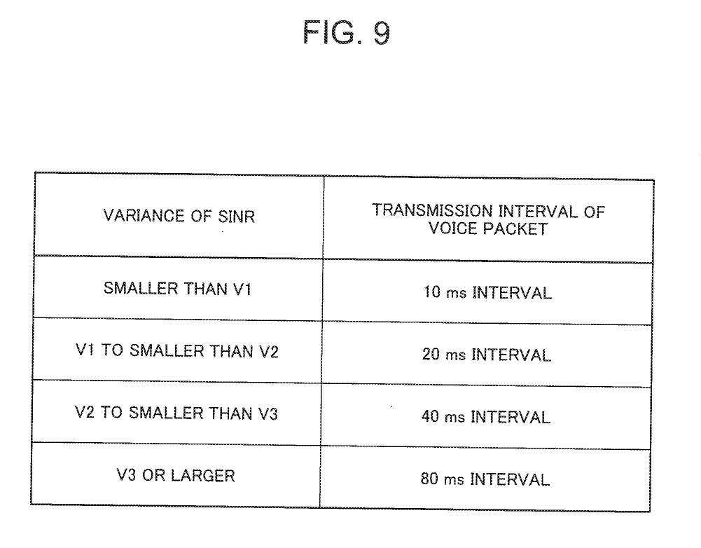

FIG. 9 is still another example of information stored in the parameter storage unit 13. In the example of FIG. 9, a transmission interval of a voice packet is stored corresponding to a variance of the SINR. For example, an entry in the first line stores that a transmission interval of a voice packet should be 10 ms when the variance of the SINR is less than V1. An entry in the second line stores that a transmission interval of a voice packet should be 20 ms when the variance of the SINR is from V1 to less than V2. Further, an entry in the fourth line stores that a transmission interval of a voice packet should be 80 ms when the variance of the SINR is V3 or higher. Here, V1, V2, and V3 are threshold values which have been set in advance.

In an example of FIG. 9, the amount of variation of a radio wave environment is evaluated by using variances V1 to V3 of the SINR, and a transmission interval of a voice packet is controlled depending on the amount of change. However, the intensity of a variation of a communication environment may be evaluated by information other than a variance of the SINR.

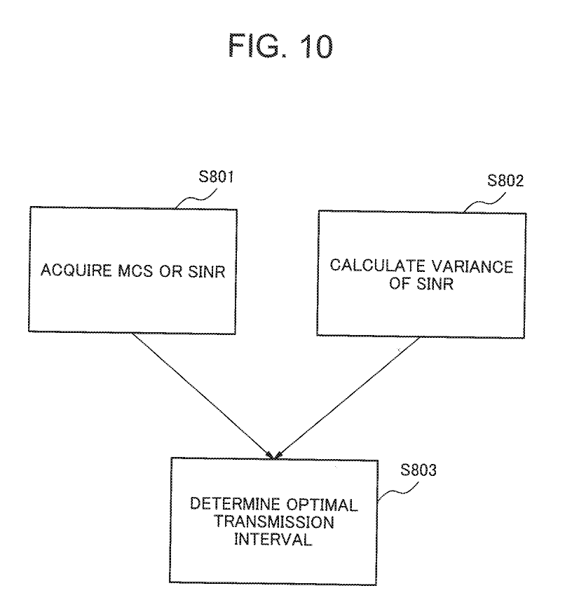

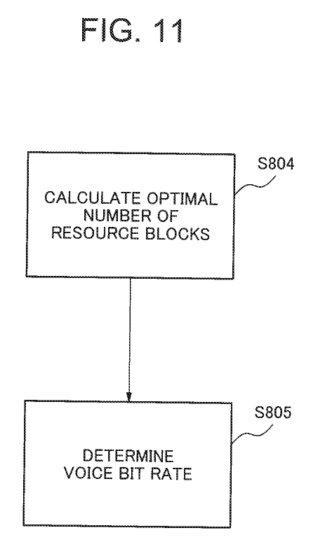

FIG. 10 and FIG. 11 are first and second flow charts, respectively, representing the operation of the data determination unit 14 in the third exemplary embodiment. In step S801 of FIG. 10, the value of an MCS or an SINR is calculated, and a transmission interval for suppressing a delay by a transmission error of control information based on the calculated value. In step S802, the variance of the SINR is calculated, and a transmission interval for suppressing a delay due to drastic deterioration of a radio wave environment is determined based on the calculated variance. In step S803, an optimal transmission interval is determined by a procedure such as selection from the result of the S801 or S802 having the larger transmission interval. In step S804 of FIG. 11, an optimal number of resource blocks to be used per unit time is determined in order to make the delay occurrence probability in a stationary environment be a certain value or smaller. In step S805, a voice bit rate is determined based on the result. In many voice codecs, a bit rate is defined for each codec class, such as 64 kbps for G.711 or 8 kbps for G.729. Therefore, by switching a voice codec class, a bit rate is controlled. In a codec in which a bit rate is variable such as AMR, the codec is not switched and the bit rate may be changed.

By performing operations as described above, a voice call having as high a bit rate as possible can be realized without generating a large delay.

Next, performing image communication such as performing videophone communication or videoconference will be studied. In the case of image communication, data input from the data input unit 15 is, for example, an image input from a camera of the smartphone 100. The data conversion unit 16 encodes an image by an image codec such as H.264, and transmits the encoded data from the communication unit 11 to the PC 200. The data conversion unit 16 controls the size and frame rate of each image frame during encoding based on an instruction from the data determination unit 14.

In the present exemplary embodiment, cases of voice communication and image communication have been described. However, the exemplary embodiment is not limited thereto. For example, when operational information input from a touch panel is transmitted, a delay can be suppressed by controlling a time interval of operational information to be transmitted or a resolution of positional information (coordinates). Similarly, in the case of communication of sensor information, a delay can be suppressed by controlling a transmission interval or accuracy of data.

### Fourth Exemplary Embodiment

In a fourth exemplary embodiment, the second exemplary embodiment is more specified.

A communication system of the fourth exemplary embodiment also has a configuration illustrated in FIG. 6 similarly to the third exemplary embodiment. The state estimation unit 12 of the present exemplary embodiment acquires and estimates a state of communication in the downward direction from the LTE base station 301 to the smartphone 100 similarly to the third exemplary embodiment, and similarly the data determination unit 14 also determines the data size and time of communication in the downward direction. Next, the data determination unit 14 instructs the determined contents to the PC 200 via the communication unit 11. The PC 200 makes communication without a delay possible by controlling the bit rate and a transmission time of a voice packet based on the instruction.

### Fifth Exemplary Embodiment

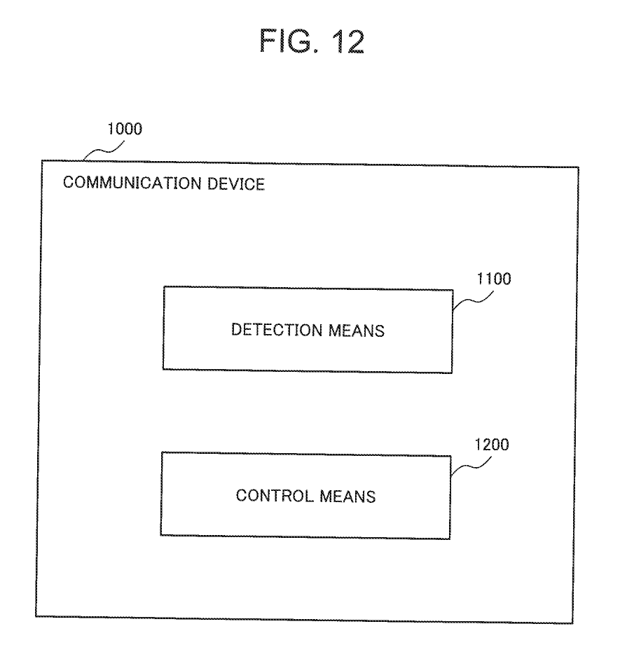

FIG. 12 is a block diagram of a communication device 1000 according to a fifth exemplary embodiment of the present invention. The communication device 1000 has a function of communicating with another communication device via a relay device which is not illustrated. The communication device 1000 comprises a detection means 1100 and a control means 1200.

The detection means 1100 has a function of detecting a state of a communication path between the relay device. The detection means 1100 may have a function of determining the state of a communication path based on at least one of a modulation system, a coding rate, and a signal-to-interference noise power ratio.

The control means 1200 has a function of controlling transmission time of data to be transmitted to another communication device depending on the state of a communication path. The control means 1200 may have a function of controlling a transmission interval of data to be transmitted depending on the state of a communication path. The control means 1200 may have a function of controlling a transmission interval of data to be transmitted depending on the amount of a variation of a state of a communication path. The control means 1200 may have a function of controlling the amount of data to be transmitted depending on a state of a communication path. The control means 1200 may have a function of controlling the amount of data to be transmitted in such a way that the amount of communication resource to be used per unit time in a communication path is a specified value or smaller. The control means 1200 may have a function of controlling the amount of data by changing a voice codec class or a bit rate to be used.

The control means 1200 may have a function of determining that the state of a communication path is deteriorated when a modulation system is changed to one having a low efficiency, when a coding rate is decreased, or when a signal-to-interference noise power ratio is decreased, and that the state of a communication path is improved when a modulation system is changed to one having a high efficiency, when a coding rate is increased, or when a signal-to-interference noise power ratio is increased.

When data is a voice packet, the control means 1200 may have a function of controlling a transmission time by changing a packetizing cycle of a voice packet.

The control means 1200 may have a function of controlling at least one of a transmission interval of data and the amount of data depending on the state of a communication path, and of performing a communication with another communication device for requesting at least one of a transmission interval of data and the amount of data to be transmitted to the own communication device 1000.

The function of the detection means 1100 and the function of the control means 1200 can be realized by a program executed by a computer included in the communication device 1000. The program may be recorded on a non-transitory fixed recording medium which the communication device 1000 comprises. As the recording medium, a semiconductor memory or a fixed magnetic disc device may be used.

In the communication device 1000 as configured above, the detection means 1100 detects a state of a communication path between the relay device, and the control means 1200 controls a transmission time of data to be transmitted to another communication device depending on the state of the communication path.

According to the communication device 1000 of the present exemplary embodiment, a communication having a higher bit rate while suppressing a delay due to a transmission error is possible. This is because the communication device 1000 controls a transmission time of data to be transmitted to another communication device depending on the state of a communication path. Usually, when the state of a communication path is poor, by starting the next data transmission after waiting for a longer time, the occurrence of a transmission error can be more suppressed. Consequently, by reducing a waiting time in a range in which the occurrence of a transmission error can be suppressed, a communication having a higher bit rate while suppressing a delay due to a transmission error is possible.

### Sixth Exemplary Embodiment

A sixth exemplary embodiment is different from the third exemplary embodiment in a determination method of a transmission interval and a voice codec class. An operational flow of a first communication device 1 of the sixth exemplary embodiment is substantially similar to FIG. 3. In the present exemplary embodiment, the state estimation unit 12 of the first communication device 1 acquires information about an ARQ or a HARQ in addition to an MCS or an SINR in the step S303 of FIG. 3, and calculates a delay until each transmitted voice packet reaches the LTE base station 301. When a transmission error does not occur, this delay is substantially zero, and when a transmission error occurs and a retransmission by an ARQ or an HARQ is performed, the delay becomes large depending on the number of ARQs or HARQs which have been performed.

Next, in step S305, the data determination unit 14 predicts a speech quality of a counterpart terminal (PC 200 in FIG. 6) when a transmission interval and a voice codec class (bit rate) are changed based on the calculated delay, and selects a combination in which the speech quality is the highest.

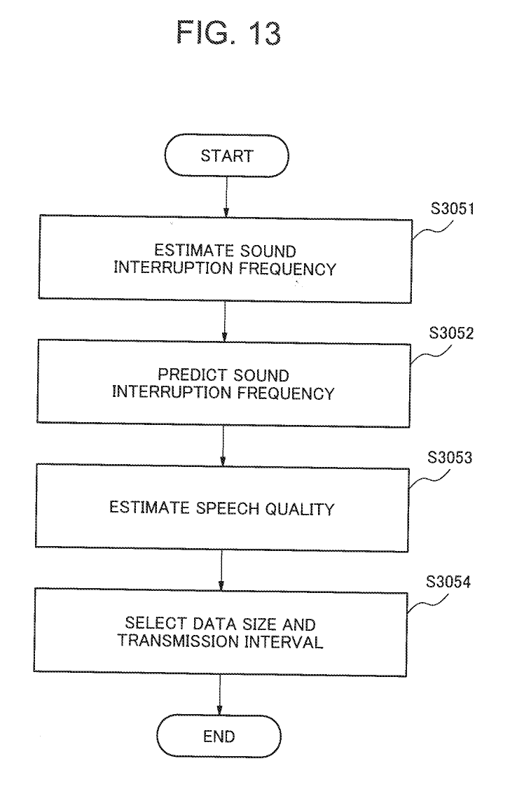

FIG. 13 is a flow chart illustrating a detailed operation of step S305 of FIG. 3 in the present exemplary embodiment. First, in step S3051, a sound interruption occurrence frequency (sound interruption occurrence frequency per unit time) in a counterpart terminal is calculated from a delay of each voice packet calculated in step S303.

Since a sound interruption occurs when arrival of a packet delays, it may be determined that a sound interruption occurs, for example, when a delay time of a packet due to retransmission is increased more than a certain value in a network between the smartphone 100 and the LTE base station 301.

Next, in step S3052, a predictive value of a sound interruption occurrence frequency when a transmission interval of a voice packet and a codec class are changed is calculated. As one example of a calculation method of a predictive value, a ratio of a sound interruption occurrence frequency to a combination of a transmission interval and a codec class is measured in advance, and a predictive value may be calculated based on a current transmission interval, an observed value of a sound interruption occurrence frequency for a codec class, and the ratio of the occurrence frequency which is measured in advance.

For example, when the ratio of sound interruption occurrence frequencies of a codec class c1 and a codec class c2 setting a packet transmission interval to 20 ms is observed to be 1:2 in advance, and when the number of sound interruptions in the codec class c1 is 10 per minute, it is predicted that, when a codec class is set to c2, the number of sound interruption is 20 per minute.

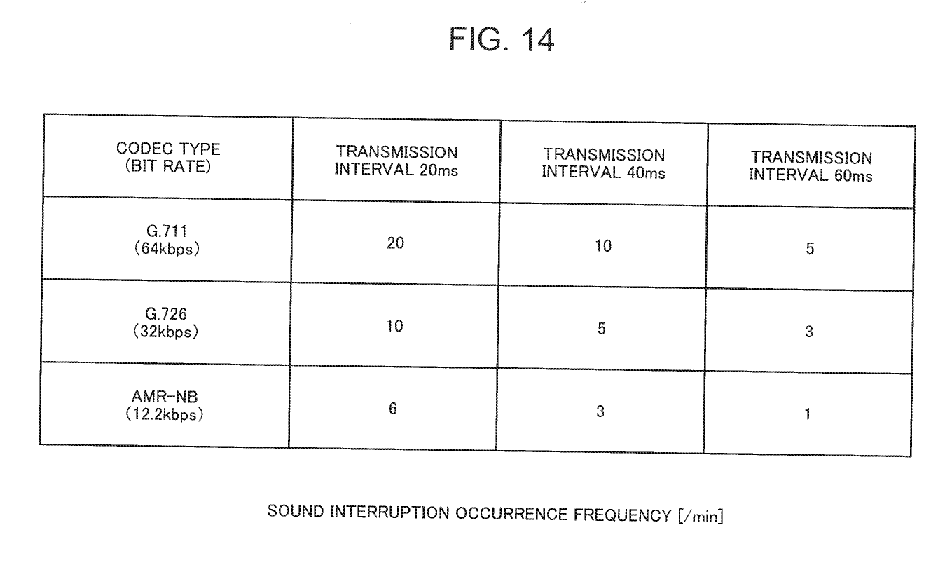

Alternatively, a sound interruption occurrence frequency may be predicted from a theoretical value of a variation of a sound interruption occurrence frequency. For example, the sound interruption occurrence frequency may be predicted by using the following two relationships. The first relationship is that when a transmission interval of a voice packet is multiplied by n times, an occurrence frequency of the sound interruption becomes 1/n. The second relationship is that when the size of a voice packet becomes 1/n, the occurrence frequency of a sound interruption becomes 1/n. FIG. 14 is one example of the occurrence frequency of a sound interruption for a transmission interval and a codec class predicted in the above-described method.

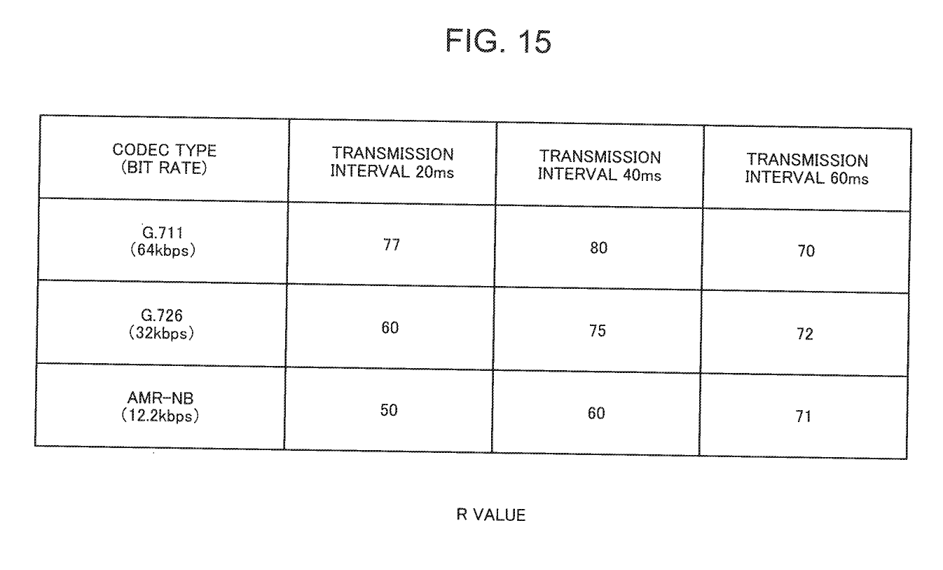

Next, in step S3053, an estimation value of a speech quality for each combination of a transmission interval and a codec class is calculated. Examples of the estimation value of a speech quality include an R value which is calculated by an E-model defined in ITU-T G.107. ITU-T is an abbreviation of The International Telecommunication Union Telecommunication standardization sector. An E-model is a method for calculating an R value (a numeral value from 0 to 100) which is an evaluation value of a speech quality from parameters such as time (mouth-to-ear delay) until a voice input from one terminal is output from a speaker of another terminal, a codec class, a packet loss rate (a sound interruption due to a delay is treated as a packet loss), and the like. FIG. 15 is an example of an R value which is calculated for the sound interruption occurrence frequency in FIG. 14.

Eventually, in step S3054, a combination of a transmission interval and a codec class in which an estimation value of a speech quality calculated in step S3053 is the best is selected. In an example of FIG. 15, since the R value when the transmission interval is 40 ms and the codec class is G.711 is the maximum (80), this combination is selected.

Next, an effect of the present exemplary embodiment will be described. In the present exemplary embodiment, a voice speech quality can be improved by determining a transmission interval of a voice packet and a codec class in consideration of deterioration of a speech quality due to a sound interruption.

### Seventh Exemplary Embodiment

A seventh exemplary embodiment is different from the sixth exemplary embodiment in that information about a delay of a packet is not acquired from information of ARQ and HARQ, but is received from a counterpart terminal.

The PC 200 of the present exemplary embodiment notifies the smartphone 100 that a sound interruption due to a delay of a packet has occurred. This notification may be transmitted immediately when a sound interruption occurs, or a sound interruption occurrence frequency may be transmitted for every fixed time.

For the notification, for example, RTCP (Real-time Transport Control Protocol) message defined in RFC (Request for Comments) 3550 can be used.

When the smartphone 100 receives a notification in the communication unit 11, the notification message is analyzed in the state estimation unit 12, and a sound interruption occurrence frequency is calculated. Operations thereafter are similar to those of the sixth exemplary embodiment.

Next, an effect of the present exemplary embodiment will be described. According to the present exemplary embodiment, since information about a delay is received from a counterpart terminal, a transmission interval and a codec class can be controlled in consideration of a voice speech quality even when wireless information of own terminal cannot be acquired.

### Eighth Exemplary Embodiment

In the sixth and the seventh exemplary embodiments, control of data transmitted from the smartphone 100 has been described. However, the procedures of the sixth and the seventh exemplary embodiments can be utilized for controlling a voice received from the PC 200 as in the second exemplary embodiment.

The first communication device 1 in the eighth exemplary embodiment determines a transmission interval and a codec class by which a voice speech quality is the best based on information of ARQ or HARQ or a sound interruption occurrence frequency, and instructs the transmission interval and the codec class to the second communication device 2.

### Other Exemplary Embodiments

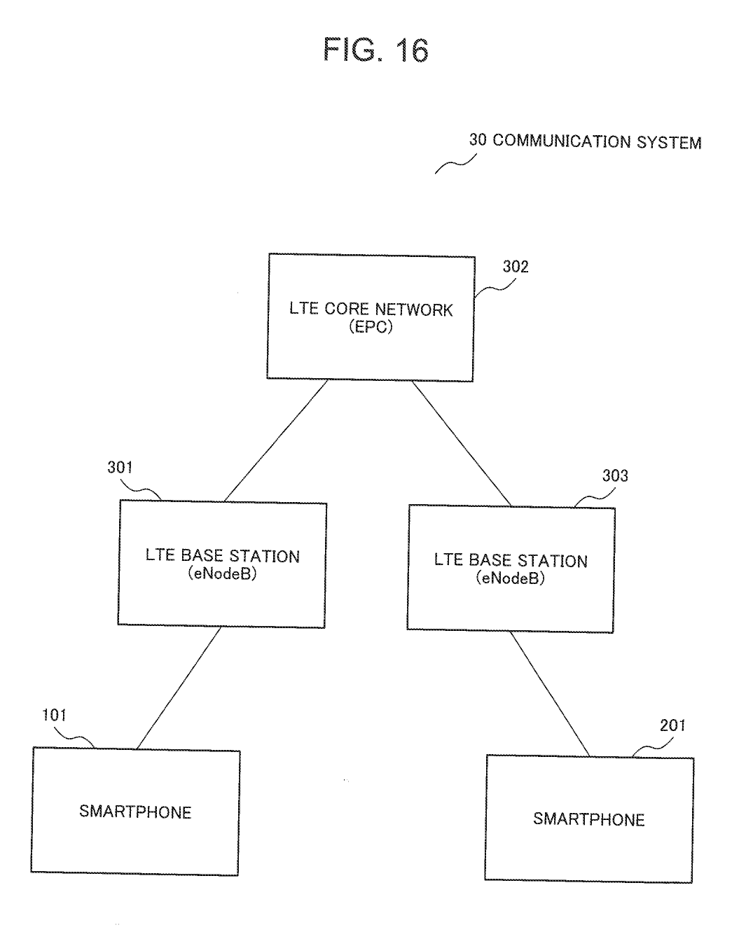

In the third and fourth exemplary embodiments, a communication between the smartphone 100 and the PC 200 connected to the LTE base station has been described. The present invention is not limited to this configuration. FIG. 16 is a configuration diagram illustrating a modified example according to the third and fourth exemplary embodiments. In a communication system 30 illustrated in FIG. 16, a communication is performed between two smartphones 101 and 201. In FIG. 16, the smartphone 101 and the smartphone 201 are connected to each other via an LTE base station 301, an LTE core network 302, and an LTE base station 303.

In each exemplary embodiment, an example in which a network is an LTE has been described. However, each exemplary embodiment can also be applied to cases in which a network is 3G, WiMAX, Wi-Fi, or the like.

Part or all of the exemplary embodiments described above can also be described as in the following Supplementary notes but is not limited thereto.

### [Supplementary Note 1]

A communication device which communicates with another communication device via a relay device, comprising:

detection means for detecting a state of a communication path between the relay device; and

control means for controlling a transmission time of data to be transmitted to the other communication device depending on the state of a communication path.

### [Supplementary Note 2]

The communication device according to Supplementary note 1, wherein the control means controls a transmission interval of the data depending on the state of a communication path.

### [Supplementary Note 3]

The communication device according to Supplementary note 1 or 2, wherein

the control means controls a transmission interval of the data depending on the amount of a variation of the state of a communication path.

### [Supplementary Note 4]

The communication device according to any one of Supplementary notes 1 to 3, wherein the control means controls the amount of the data to be transmitted depending on the state of a communication path.

### [Supplementary Note 5]

The communication device according to Supplementary note 4, wherein

the control means controls the amount of the data in such a way that the amount of communication resource to be used per unit time in the communication path is a specified value or smaller.

### [Supplementary Note 6]

The communication device according to any one of Supplementary notes 1 to 5, wherein

the control means estimates a quality evaluation value when at least one of the transmission time, the transmission interval, and the amount of the data to be transmitted via the communication path is changed, and controls at least one of the transmission time, the transmission interval, and the amount of the data based on the quality evaluation value.

### [Supplementary Note 7]

The communication device according to Supplementary note 6, wherein the control means predicts a sound interruption occurrence frequency of a voice call when at least one of the transmission time, the transmission interval, and the amount of the data is changed, and calculates the quality evaluation value by using the sound interruption occurrence frequency.

### [Supplementary Note 8]

The communication device according to Supplementary note 7, wherein the control means predicts the sound interruption occurrence frequency when the transmission time, the transmission interval, and the amount of the data are changed based on a past sound interruption occurrence frequency.

### [Supplementary Note 9]

The communication device according to any one of Supplementary notes 6 to 8, wherein the control means selects the transmission interval and the amount of the data in which the quality evaluation value is the highest.

### [Supplementary Note 10]

The communication device according to any one of Supplementary notes 1 to 9, wherein

the detection means determines the state of a communication path based on at least one of a modulation system, a coding rate, and a signal-to-interference noise power ratio.

### [Supplementary Note 11]

The communication device according to Supplementary note 10, wherein

the control means determines that the state of a communication path is deteriorated when a modulation system is changed to one having a low efficiency, when a coding rate is decreased, or when a signal-to-interference noise power ratio is decreased, and that the state of a communication path is improved when a modulation system is changed to one having a high efficiency, when a coding rate is increased, or when a signal-to-interference noise power ratio is increased.

### [Supplementary Note 12]

The communication device according to any one of Supplementary notes 1 to 11, wherein

the data is a voice packet, and

the control means controls a transmission time by changing a packetizing cycle of the voice packet.

### [Supplementary Note 13]

The communication device according to any one of Supplementary notes 4 to 11, wherein

the control means controls the amount of the data by changing a voice codec class or a bit rate to be used.

### [Supplementary Note 14]

The communication device according to Supplementary note 1, wherein

the control means controls at least one of the transmission interval of the data and the amount of data depending on the state of a communication path, and performs a communication with the other communication device for requesting at least one of the transmission interval of the data and the amount of the data.

### [Supplementary Note 15]

A communication system in which a first communication device and a second communication device perform a communication via a relay device, wherein

the first communication device comprises:

detection means for detecting a state of a communication path to the relay device; and

control means for controlling a transmission time of data to be transmitted to the second communication device depending on a state of the communication path.

### [Supplementary Note 16]

The communication system according to Supplementary note 15, wherein

the control means of the first communication device controls the transmission interval of the data depending on the state of the communication path.

### [Supplementary Note 17]

The communication system according to Supplementary note 15 or 16, wherein

the control means of the first communication device controls the transmission interval of the data depending on the amount of a variation of the state of the communication path.

### [Supplementary Note 18]

The communication system according to any one of Supplementary notes 15 to 17, wherein

the control means of the first communication device controls the amount of the data to be transmitted depending on the state of the communication path.

### [Supplementary Note 19]

The communication system according to Supplementary note 18, wherein

the control means of the first communication device controls the amount of the data in such a way that the amount of a communication resource to be used per unit time in the communication path is a specified value or smaller.

### [Supplementary Note 20]

The communication system according to any one of Supplementary notes 15 to 19, wherein

the control means estimates a quality evaluation value when at least one of the transmission time, the transmission interval, and the amount of the data to be transmitted via the communication path is changed, and controls at least one of the transmission time, the transmission interval, and the amount of the data based on the quality evaluation value.

### [Supplementary Note 21]

The communication system according to Supplementary note 20, wherein the control means predicts a sound interruption occurrence frequency of a voice call when at least one of the transmission time, the transmission interval, and the amount of the data is changed, and calculates the quality evaluation value by using the sound interruption occurrence frequency.

### [Supplementary Note 22]

The communication system according to Supplementary note 21, wherein the control means predicts the sound interruption occurrence frequency when the transmission time, the transmission interval, and the amount of the data are changed based on a past sound interruption occurrence frequency.

### [Supplementary Note 23]

The communication system according to any one of Supplementary notes 20 to 22, the control means selects the transmission interval and the amount of the data in which the quality evaluation value is the highest.

### [Supplementary Note 24]

The communication system according to any one of Supplementary notes 15 to 23, wherein

the detection means of the first communication device determines the state of a communication path based on at least one of a modulation system, a coding rate, and a signal-to-interference noise power ratio.

### [Supplementary Note 25]

The communication system according to Supplementary note 24, wherein

the control means of the first communication device determines that the state of a communication path is deteriorated when a modulation system is changed to one having a low efficiency, when a coding rate is decreased, or when a signal-to-interference noise power ratio is decreased, and that the state of a communication path is improved when a modulation system is changed to one having a high efficiency, when a coding rate is increased, or when a signal-to-interference noise power ratio is increased.

### [Supplementary Note 26]

The communication system according to any one of Supplementary notes 15 to 25, wherein

the data is a voice packet, and

the control means of the first communication device controls a transmission time by changing a packetizing cycle of the voice packet.

### [Supplementary Note 27]

The communication system according to any one of Supplementary notes 18 to 25, wherein

the control means of the first communication device controls the amount of the data by changing a voice codec class or a bit rate to be used.

### [Supplementary Note 28]

The communication system according to Supplementary note 15, wherein

the control means of the first communication device controls at least one of the transmission interval of the data and the amount of data depending on the state of a communication path, and performs a communication with the other communication device for requesting at least one of the transmission interval of the data and the amount of the data.

### [Supplementary Note 29]

A communication control method executed by a communication device which communicates with another communication device via a relay device, comprising:

detecting a state of a communication path between the relay device; and

controlling a transmission time of data to be transmitted to the other communication device depending on a state of the communication path.

### [Supplementary Note 30]

A program for making

a computer which communicates with a communication device via a relay device function as:

detection means for detecting a state of a communication path to the relay device; and

control means for controlling a transmission time of data to be transmitted to the other communication device depending on the state of the communication path.

The present invention has been described with reference to the exemplary embodiments. However, applicable aspects of the present invention are not restricted to the above-described exemplary embodiments. The configuration or a detailed description of the present invention may be modified in various ways which can be understood by those skilled in the art within a scope of the present invention.

This application claims the priority based on Japanese Patent Application No. 2014-105797 filed on May 22, 2014, the entire disclosure of which is incorporated herein by reference.

### INDUSTRIAL APPLICABILITY

The present invention can be utilized, for example, for a real time service such as a voice call, a videophone, a video game, or a thin client system via a mobile network such as an LTE.

### REFERENCE SIGNS LIST

1 First communication device
2 Second communication device
3 Relay device
10, 20, 30 Communication system
11 Communication unit
12 State estimation unit
13 Parameter storage unit
14 Data determination unit
15 Data input unit
16 Data conversion unit
100, 101, 200, 201 Smartphone
301 LTE base station (eNodeB)
302 LTE core network (EPC)
1000 Communication device
1100 Detection means
1200 Control means

What is claimed is:

1. A communication device which communicates with another communication device via a relay device, comprising:
a detection unit that detects a state of a communication path to the relay device; and
a control unit that controls a transmission time of data to be transmitted to the other communication device depending on the state of a communication path.

2. The communication device according to claim 1, wherein
the control unit controls a transmission interval of the data depending on the state of a communication path.

3. The communication device according to claim 1, wherein
the control unit controls a transmission interval of the data depending on the amount of a variation of the state of a communication path.

4. The communication device according to claim 1, wherein
the control unit controls the amount of the data to be transmitted depending on the state of a communication path.

5. The communication device according to claim 4, wherein
the control unit controls the amount of the data in such a way that the amount of communication resource to be used per unit time in the communication path is a specified value or smaller.

6. The communication device according to claim 1 wherein
the control unit estimates a quality evaluation value when at least one of the transmission time, the transmission interval, and the amount of the data to be transmitted via the communication path is changed, and controls at least one of the transmission time, the transmission interval, and the amount of the data based on the quality evaluation value.

7. The communication device according to claim 1, wherein
the control unit controls at least one of the transmission interval of the data and the amount of data depending on the state of a communication path, and performs a communication with the other communication device for requesting at least one of the transmission interval of the data and the amount of the data.

8. A communication control method executed by a communication device which communicates with another communication device via a relay device, comprising:
detecting a state of a communication path to the relay device; and
controlling a transmission time of data to be transmitted to the other communication device depending on a state of the communication path.

9. (canceled)

10. A communication system in which a first communication device and a second communication device perform a communication via a relay device, wherein
the first communication device comprises:
a detection unit that detects a state of a communication path to the relay device; and
a control unit that controls a transmission time of data to be transmitted to the second communication device depending on a state of the communication path.

11. The communication device according to claim 2, wherein
the control unit controls a transmission interval of the data depending on the amount of a variation of the state of a communication path.

12. The communication device according to claim 2, wherein
the control unit controls the amount of the data to be transmitted depending on the state of a communication path.

13. The communication device according to claim 2, wherein
the control unit estimates a quality evaluation value when at least one of the transmission time, the transmission interval, and the amount of the data to be transmitted via the communication path is changed, and controls at least one of the transmission time, the transmission interval, and the amount of the data based on the quality evaluation value.

14. The communication device according to claim 3, wherein
the control unit controls the amount of the data to be transmitted depending on the state of a communication path.

15. The communication device according to claim 3, wherein
the control unit estimates a quality evaluation value when at least one of the transmission time, the transmission interval, and the amount of the data to be transmitted via the communication path is changed, and controls at least one of the transmission time, the transmission interval, and the amount of the data based on the quality evaluation value.

16. The communication device according to claim 4, wherein
the control unit estimates a quality evaluation value when at least one of the transmission time, the transmission interval, and the amount of the data to be transmitted via the communication path is changed, and controls at least one of the transmission time, the transmission interval, and the amount of the data based on the quality evaluation value.

17. The communication device according to claim 5, wherein
the control unit estimates a quality evaluation value when at least one of the transmission time, the transmission interval, and the amount of the data to be transmitted via the communication path is changed, and controls at least one of the transmission time, the transmission interval, and the amount of the data based on the quality evaluation value.
